(19) United States
(12) Patent Application Publication
(10) Pub. No.: US 2024/0349320 A1
(43) Pub. Date: Oct. 17, 2024

(54) DEPLOYING RESOURCES IN A NETWORK

(71) Applicant: SOLUTIONS HUMANITAS INC., Montréal (CA)

(72) Inventors: Adbo SHABAH, Montréal (CA); Mehdi ASADI, Montreal (CA); Maroua BEN ATTIA, Montreal (CA)

(21) Appl. No.: 18/536,140

(22) Filed: Dec. 11, 2023

Related U.S. Application Data
(60) Provisional application No. 63/431,659, filed on Dec. 9, 2022.

(51) Int. Cl. H04W 72/52; H04W 24/02; H04W 72/51

(52) U.S. Cl. CPC H04W 72/52; H04W 24/02; H04W 72/51

(57) ABSTRACT

A method and a system deploying resources in a network that comprises a plurality of network nodes composed of served nodes and serving nodes, the serving nodes comprising a plurality of cluster heads. A served geographic zone is divided into a plurality of multidimensional horizontal clusters based on a multi-dimensional vector of different features (number of the served nodes, position values of the served nodes, traffic flow type). One CH node is assigned to each multidimensional horizontal cluster considering capacity of the assigned CH node and deployment delay of the assigned CH node. One serving node is assigned to each multidimensional horizontal clusters considering capacity of the assigned serve node; required capacity to serve a particular one of the multidimensional horizontal clusters; and a distance constraint between two or more of the served nodes to avoid wireless-interference.

### PRIORITY STATEMENT UNDER 35 U.S.C § 0.119 (E) & 37 C.F.R. § 0.1.78

This non-provisional patent application claims priority based upon the prior U.S. provisional patent application entitled “Distributed adaptive network: Planning & Routing”, application No. 63/431,659, filed 2022 Dec. 9, in the name of Solutions Humanitas Inc., which is hereby incorporated by reference in its entirety.

### TECHNICAL FIELD

The present invention relates to a method and system for deploying network resources and, more particularly, to a method and system for deploying network resources in network with a mobile infrastructure.

### BACKGROUND

Deploying resources in a network is always a challenge and the challenge simply increases when some network nodes of the infrastructure are mobile as well as served nodes.

The present disclosure aims at improving network deployment in such circumstances.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Current systems often leverage centralized control mechanism or semi-distributed architectures that rely on cloud computer or edge computing paradigms to manage network resources and traffic flow. These systems are designed to handle a large number of nodes and data traffic, providing dynamic resources allocation and network orchestration. These systems are often limited by scalability and the ability to adapt to real-time changes in network topology and conditions. The system and method presented herein addresses some of these limitations.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method is provided for deploying resources in a network, the network comprising a plurality of network nodes composed of served nodes and serving nodes, the serving nodes comprising a plurality of cluster heads. The method comprises dividing a served geographic zone into a plurality of multidimensional horizontal clusters based on a multi-dimensional vector of different features. The multi-dimensional vector of different features included number of the served nodes, position values of the served nodes and traffic flow type values for the served nodes. The method also comprises assigning one of the CH nodes to each of the plurality of multidimensional horizontal cluster performed considering capacity of the assigned CH node and deployment delay of the assigned CH node. The method also further comprises assigning one of the serving nodes to the each of the plurality of multidimensional horizontal clusters performed considering capacity of the assigned serving node, required capacity to serve a particular one of the plurality of multidimensional horizontal clusters and a distance constraint between two or more of the served nodes to avoid wireless-interference. Other embodiments of this aspect include corresponding computer systems, apparatus, and computer programs recorded on one or more computer storage devices, each configured to perform the actions of the methods.

Implementations may include one or more of the following features. Each of the plurality of multidimensional horizontal clusters may further be divided in subzones. In some instances, the method may include automatically triggering repositioning of one or more serving nodes in the network considering dynamic thresholds. The dynamic thresholds may be related to one or more of remaining execution time in terms of network resources, computational resources and/or storage resources; energy/power requirements; deployment/execution delay of one or more serving nodes; predicted time of the environment condition changes; and remaining time for displacing the one or more serving node to the center of a target subzone.

In some instances, the method may include dividing each of the plurality of horizontal multidimensional clusters (HMC) into a plurality of sub-clusters (sub-HMC clusters); assigning a subset of the network nodes to each of the plurality of sub-clusters thereby defining vertical multidimensional clusters (VMC) of network nodes, dividing each of the sub-HMC clusters into sub-sub-HMC clusters and so on thereby creating a hierarchy of clusters of network nodes. Alternatively or additionally, the method may include self-tuning deployment of resources in the network by proactively executing a cost-optimization function considering a set of constraints such as geographic zone of the served nodes; position of the network nodes; mobility capabilities of the network nodes; energy capabilities of network nodes; resource requirements of the network nodes; type of the network nodes; type of the served traffic flow; and—instantaneous bandwidth (IBW) whereby various ones of the network nodes can belong to a given cluster when sharing similar cost functions. Alternatively or additionally, the method may include tuning a subset of the constraints for optimizing stability, security, safety and radio network performance in the network.

In some instances, the method may alternatively or additionally include determine traffic route in the network by iterating: at each of the network nodes, maintaining a list of adjacent network nodes; at each node, broadcasting a state vector containing link costs with adjacent network nodes; at each node, creating a matrix of link costs between all pairs of the network nodes; based on this matrix, each of the serving nodes computing a shortest path to a core network; and assigning active ones of the served nodes to proper ones of the serving nodes considering the computed shortest paths. The iteration may be performed until a converging solution is found. Alternatively or additionally, the method may include, at each node, computing the costs of the link with adjacent nodes as a product of a network function and the feasibility of that link considering that a link is feasible if all constraints are met, a constraint is defined for each metric, a cost of an infeasible link is infinite. Implementations of the described techniques may include hardware, a method or process, or a computer tangible medium.

In one general aspect, a system is provided that comprises a network having a plurality of network nodes composed of served nodes and serving nodes, the serving nodes having a plurality of cluster heads. The system may also include one or more processors configured to: divide a served geographic zone into a plurality of multidimensional horizontal clusters based on a multi-dimensional vector of different features (e.g., considering number of the served nodes; position values of the served nodes; and traffic flow type values for the served nodes); assign one of the CH nodes to each of the plurality of multidimensional horizontal clusters (e.g., considering capacity of the assigned CH node; and deployment delay of the assigned CH node); assign one of the serving nodes to the each of the plurality of multidimensional horizontal clusters (e.g., considering capacity of the assigned serve node; required capacity to serve a particular one of the plurality of multidimensional horizontal clusters; and a distance constraint between two or more of the served nodes to avoid wireless-interference). Other embodiments of this aspect include corresponding computer systems, apparatus, and computer programs recorded on one or more computer storage devices, each configured to perform the actions of the methods.

### BRIEF DESCRIPTION OF THE DRAWINGS

Further features and exemplary advantages of the present invention will become apparent from the following detailed description, taken in conjunction with the appended drawings, in which:

FIG. 1 is a flow chart of an exemplary method in accordance with the teachings of the present invention;

FIG. 2 is a modular representation of an exemplary network node in accordance with the teachings of the present invention; and

FIG. 3 is a flow and nodal operation of an exemplary method in accordance with the teachings of the present invention.

### DETAILED DESCRIPTION

A method for deploying resources in a network is presented. The method ensures comprehensive network coverage by employing a placement strategy for network nodes. Network nodes may include eNBs or gNBs for example. The placement strategy takes into consideration the potential network resource outages within specific geographic locations, triggered by environmental conditions such as adverse weather, depletion of battery, and computation and storage requirements for example. Other factors may as well be considered, such as a prediction of a lack of resources limiting the coverage of a specific geographic area. Resources may relate to the network capacity, for example the number of resource blocks (RBs) or frequency bands in 3GPP standard when serving a large number of users, for instance when users migrate from one geographic area to another or when a large number of users request high bandwidth traffic.

The served geographic zone may be divided into several multidimensional horizontal clusters (HMC). The clusters may be segmented based on multi-dimensional vectors including different features such as the number of served nodes, the position of the served nodes and the expected traffic flow type for the served nodes. The number of served nodes may refer to the quantity of network nodes, such as base stations (e.g., eNBs or gNBs), that are actively providing coverage and connectivity to User Equipment within a particular area or cluster. The served nodes may be responsible for handling the communication and data exchange between the devices on the network and the core network infrastructure. A higher number of served nodes in a cluster might indicate a denser network with potentially higher capacity to manage larger volumes of traffic, whereas a lower number could signify a sparser network that may face challenges in servicing a high number of user devices or handling high traffic loads. The position of the served nodes refers to the geographic location or coordinates of where the network nodes may be deployed. Within the network. The positioning of the node may be important to ensure coverage, signal quality and ensure network capacity and resilience through redundancy while avoiding interference which may degrade the network's performance. Different traffic flow types may also drive different requirements on the system. For example, critical or emergency traffic results in different geographic divisions. For example, critical or emergency traffic type may require higher reliability and lower latency than best effort traffic type. Other traffic types may be identified, such as delay-sensitive traffic, high bandwidth traffic, realt-time interactive traffic, background traffic or burst traffic for example.

A cluster head node may be assigned to each of the multidimensional horizontal clusters. The candidates for cluster head assignment may be evaluated based on their capacity and deployment delay to find an optimal match considering the expected serving demands of the cluster. In the context of the cluster head election, capacity may refer to a combination of the computation power, storage, energy resources and network capabilities of the node. The deployment delay may refer to the time required to deploy or position a cluster head node within a specific subzone. The serving nodes may be assigned to each of the multidimensional horizontal clusters considering. The assignment may be optimized in consideration of the capacity of the serving node, the required capacity to serve a particular multidimensional horizontal cluster and the distance between two or more of the served node to avoid wireless-interference. The capacity of the serving nodes may include the inherent capabilities of the service node, including their computational power, storage resources, energy availability to ensure that demand can be handled in each subzone. As a few examples, the demand in each subzone may be anticipated from historical data analysis, real-time monitoring, predictive algorithms, event-based projections, expected mobility patterns, user behavior, service level agreements or other environmental factors such as expected changes in weather, natural disasters or any other environmental factor that may impact network usage. The distance between the serving nodes may be evaluated to minimize wireless interference between the nodes while ensuring coverage. The distance may be further evaluated to enable load balancing, minimize latency and maximum resource utilization by avoiding scenarios where multiple nodes may be covering the same area unnecessarily.

In some embodiments, the clusters may be further divided horizontally into subzones. Subzones may cover a smaller geographic area within the larger area covered by a cluster with each subzone having its own specific network demand and characteristics which may be considered when determining the optimal placement of the nodes and assignment of resources.

In some embodiments, the clusters may also be further divided vertically into horizontal multidimensional sub-clusters (sub-HMC) to create vertical multidimensional clustering (VMC). Sub-clusters may be organizational subdivision representing a group of network nodes working together within the cluster's hierarchy. Sub-clusters may extend across multiple subzones or be confined to a single subzone, depending on the network's structure and management strategy. The sub-clusters may create a layered, vertical structure within the cluster organization with a cluster head at each level managing their respective sub-clusters. In some embodiments, the VMC may be further subdivided into sub-sub-HMC. The sub-sub-HMC creates additional layers within the VMC, allowing for even more granular control and management of network resources and traffic flows within specific geographic zones or areas of demand. Each level of this hierarchy may have its own cluster head for localized management, contributing to the overall efficiency and responsiveness of the network system.

Each serving node may continuously monitor various performance metrics related to the network conditions and resource utilization. For example, network resource level, including resource blocks and bandwidth, computational resources, storage capacity and energy levels may be continuously monitored. Monitored values may be further associated with dynamic thresholds and a decision-making algorithm used to trigger the repositioning of the nodes. The algorithm may determine which serving nodes should be repositioned to address the identified needs in order to improve coverage, reduce latency or improve the load balancing among the nodes.

The dynamic thresholds may consider the remaining execution time in terms of network resources, the computational resources and/or storage resources, energy/power requirements, deployment/execution delay of one or more serving nodes, predicted time of the environment condition changes; and remaining time for displacing the one or more serving node to the center of a target subzone.

The deployment of resources in the network may be self-tuned by proactively executing a cost-optimization function. The process may include defining the cost optimization function, setting the optimization constraints, monitoring the network state, self-tuning, evaluating cost across potential configurations, executing the proactive deployment and feeding back in a loop for continuous improvement. The cost-optimization function may consider constrains such as the geographic zone of the served nodes, the position of the network nodes, mobility capabilities of the network nodes, energy capabilities of network nodes, resource requirements of the network nodes, type of the network nodes, type of the served traffic flow and instantaneous bandwidth (IBW). The geographic zone of the served nodes may be described as the specific physical area within which user equipment (UE) operates, influencing the placement and distribution of network resources to ensure adequate coverage and service quality. The position of the network nodes may be described as the fixed or variable location of infrastructure elements like base stations or access points, which affects signal strength, network coverage, and connectivity. The mobility capabilities of the network nodes may be described as the ability of certain network components, such as drones or mobile base stations, to move and reposition in response to changing network demands or environmental factors. The energy capabilities of network nodes may be described as the power resources available to a node, including battery life and energy generation or consumption rates, which dictate the node's operational longevity and performance. The resource requirements of the network nodes may be described as the specific computational, storage, and networking needs essential for a node to function efficiently and meet the service demands placed upon it. The type of the network nodes may be described as the classification of nodes based on their roles and technologies, such as High Altitude Platform Stations (HAPS), Unmanned Aerial Vehicles (UAVs), or ground-based stations, each with distinct deployment and operational characteristics. The type of the served traffic flow may be described as the category of data transmission over the network, characterized by its latency sensitivity, bandwidth consumption, and priority, such as real-time communication or bulk data transfer. The instantaneous bandwidth (IBW) may be described as the current width of the frequency band available for data transmission, which impacts the data rate and the number of concurrent users or services the network can support at any given moment.

In one embodiment, when network nodes are found to share similar cost-optimization functions, they may be clustered together.

In one embodiment, the subset of constraints may be tuned for optimizing stability, security, safety and radio network performance in the network. The stability objective of the self-tuning may be described as the network's ability to maintain consistent and reliable performance over time, minimizing fluctuations in connectivity and service quality due to changing conditions or load variations.

The security objective of the self-tuning may be described as the network's capacity to protect data integrity and confidentiality, as well as ensuring availability against various threats, by dynamically adjusting its parameters in response to detected vulnerabilities or potential attacks. The safety objective of the self-tuning may be described as the network's adherence to protocols and mechanisms that prevent system failures or malfunctions, which could lead to service outages or harm to users and equipment. The radio network performance objective of the self-tuning may be described as the optimization of wireless communication quality, aiming to maximize throughput, minimize latency, and extend coverage by continuously refining the allocation of radio resources and network configurations.

Traffic routes may be determined in the network in an iterative manner until a converging solution is found. Using a list of adjacent nodes, each node may broadcast a state vector including the link costs with adjacent network nodes. Upon receiving the adjacent state vectors, each node may create a matrix of link costs between all pairs of the network nodes. Each of the serving nodes may also compute a shortest path to a core network. Upon combining the costs and shortest path matrices, each serving node may assign active served nodes to proper ones of the serving nodes. Describing the state may include the process where each node within the network gathers detailed information about its connectivity with neighboring nodes, such as signal-to-noise ratio (SNR), link quality metrics, and distance. The cost may reflect the quality and feasibility of the links, incorporating the various network metrics and constraints. The cost vectors may be shared to other nodes through their respective cluster heads. The shortest path analysis may include the use of routing algorithms, like Dijkstra's algorithm, applied to the matrix of link costs to compute the most efficient route from each node to the core network, minimizing the cumulative cost associated with traversing through the network's topology. After the initial assignment, the network may undergo changes, such as traffic variations or node mobility, that necessitate adjustments to the routing. The process is repeated, collecting new data, recalculating costs, and reassigning path, until a stable routing configuration is achieved. The iterative process continues until the routing decisions converge, meaning that subsequent iterations yield the same or sufficiently similar results, indicating a stable routing solution has been found. Once a convergent solution is established, the network implements the necessary changes, such as establishing new links or initiating handovers, to reflect the optimized traffic routes.

During the traffic route optimization process, each node may further compute the costs of the link with adjacent nodes as a product of a network function and the feasibility of that link. A link may be considered feasible when all constraints are met. When constraints are met, the cost may be defined as the computed cost, but when constraints are not met, the cost may be replaced by an infinite cost to represent the link as infeasible.

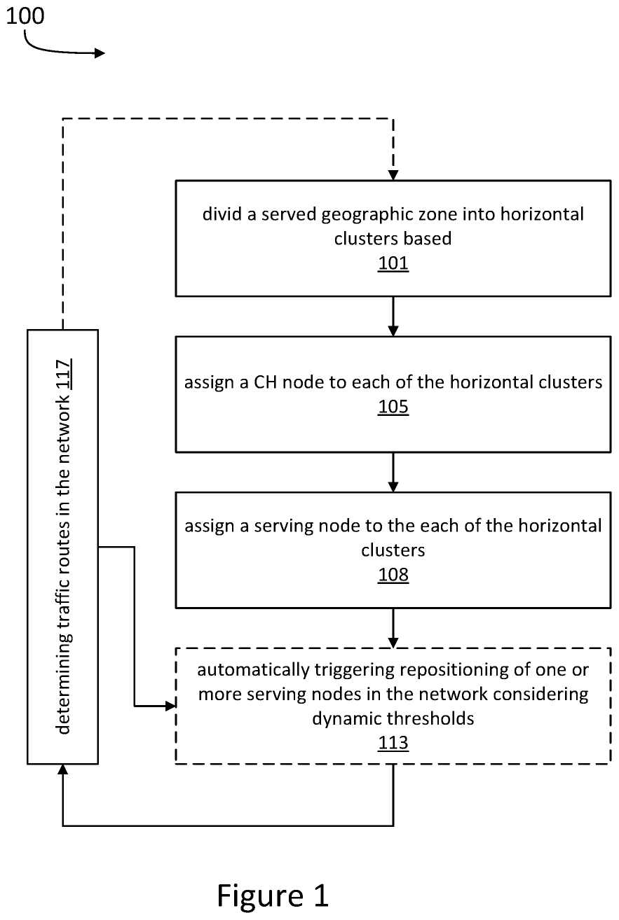

FIG. 1 shows a flowchart of an example method 100 for deploying resources in a network, the network comprising a plurality of network nodes composed of served nodes and serving nodes, the serving nodes comprising a plurality of cluster heads. In some implementations, one or more method blocks of FIG. 1 may be performed by a device. As shown in FIG. 1, the method 100 comprises dividing 101 a served geographic zone into a plurality of multidimensional horizontal clusters based on a multi-dimensional vector of different features. The multi-dimensional vector of different features may include number of the served nodes, position values of the served nodes, traffic flow type values for the served nodes. The method 100 also comprises assigning 105 one of the CH nodes to each of the plurality of multidimensional horizontal clusters. The assigning 105 may take into account include capacity of the assigned CH node and deployment delay of the assigned CH node. The method 100 also comprises assigning 108 one of the serving nodes to the each of the plurality of multidimensional horizontal clusters. The assigning block 108 may consider capacity of the assigned serving node, required capacity to serve a particular one of the plurality of multidimensional horizontal clusters and a distance constraint between two or more of the served nodes to avoid wireless-interference. Optionally, the method 100 may further comprise automatically triggering 113 repositioning of one or more serving nodes in the network considering dynamic thresholds. As another option, determining 117 traffic routes in the network may be iteratively performed until a converging solution is found.

Although FIG. 1 shows example blocks of the method 100, in some implementations, the method 100 may include additional blocks, fewer blocks, different blocks, or differently arranged blocks than those depicted in FIG. 1. Additionally, or alternatively, two or more of the blocks of method 100 may be performed in parallel. Skilled persons will also readily recognize the manner in which the method 100 may iterate through different portions thereof, especially in the context of resolution of optimization problems.

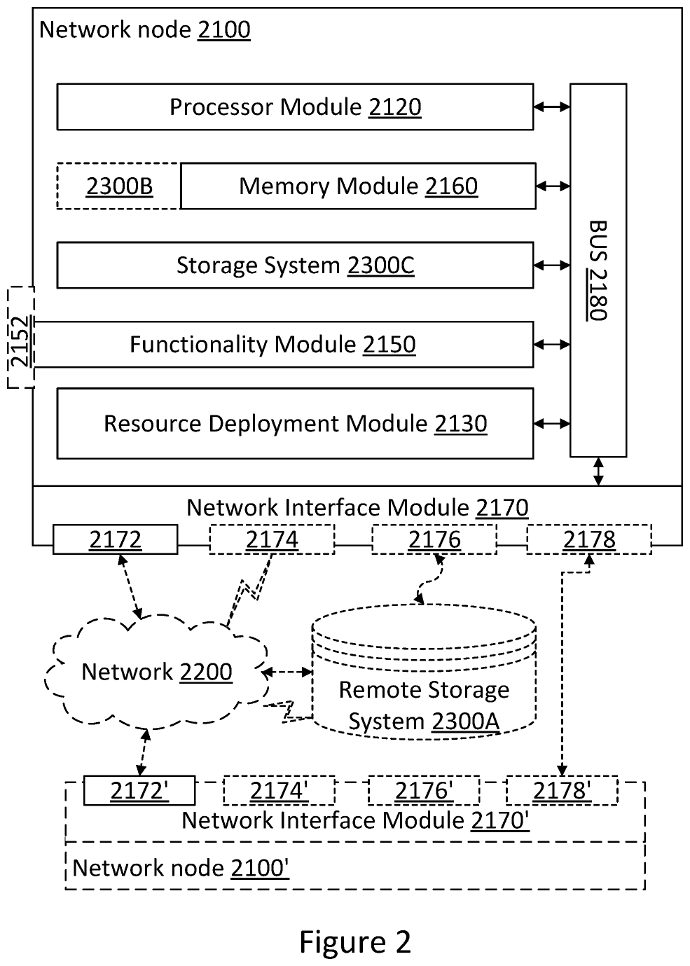

FIG. 2 shows a logical modular representation of an exemplary system 2000 comprising a network node 2100. The network node 2100 comprises a memory module 2160 and a processor module 2120. Optionally, a user interface module (not shown) may be provided as well as a functionality module 2150. The network node comprises a network interface module 2170. The system 2000 may also include a storage system 2300. The system 2000 includes a network 2200 that may be used for accessing storage system 2300 or other nodes (e.g., 2100′).

The network node 2100 may comprise a storage system 2300 for storing and accessing long-term (i.e., non-transitory) data and may further log data while the innovation accelerator system is being used. FIG. 2 shows examples of the storage system 2300 as a distinct database system 2300A, a distinct module 2300C of the network node 2100 or a sub-module 2300B of the memory module 2160 of the network node 2100. The storage system 2300 may be distributed over different systems A, B, C. The storage system 2300 may comprise one or more logical or physical as well as local or remote hard disk drive (HDD) (or an array thereof). The storage system 2300 may further comprise a local or remote database made accessible to the network node 2100 by a standardized or proprietary interface or via the network interface module 2170. The variants of storage system 2300 usable in the context of the present invention will be readily apparent to persons skilled in the art.

In the depicted example of FIG. 2, the network node 2100 shows an optional remote storage system 2300A which may communicate through the network 2200 with the network node 2100. The storage module 2300, (e.g., a networked data storage system) accessible to all modules of the network node 2100 via the network interface module 2170 through a network 2200, may be used to store data. The storage system 2300 may represent one or more logical or physical as well as local or remote hard disk drive (HDD) (or an array thereof). The storage system 2300 may further represent a local 2300B, 2300C or remote database 2300A made accessible to the network node 2100 by a standardized or proprietary interface. The network interface module 2170 represents at least one physical interface that can be used to communicate with other network nodes. The network interface module 2170 may be made visible to the other modules of the network node 2100 through one or more logical interfaces. The actual stacks of protocols used by the physical network interface(s) and/or logical network interface(s) of the network interface module 2170 do not affect the teachings of the present invention. The variants of processor module 2120, memory module 2160, network interface module 2170 and storage system 2300 usable in the context of the present invention will be readily apparent to persons skilled in the art.

A resource deployment module 2130 may cooperate with various other modules of the network node 2100. Likewise, even though explicit mentions of the memory module 2160 and/or the processor module 2120 are not made throughout the description of the present examples, persons skilled in the art will readily recognize that such modules are used in conjunction with other modules of the network node 2170 to perform routine as well as innovative steps related to the present invention.

The processor module 2120 may represent a single processor with one or more processor cores or an array of processors, each comprising one or more processor cores. The memory module 2160 may comprise various types of memory (different standardized or kinds of Random Access Memory (RAM) modules, memory cards, Read-Only Memory (ROM) modules, programmable ROM, etc.). The network interface module 2170 represents at least one physical interface that can be used to communicate with other network nodes. The network interface module 2170 may be made visible to the other modules of the network node 2100 through one or more logical interfaces. The actual stacks of protocols used by the physical network interface(s) and/or logical network interface(s) 2172-2178 of the network interface module 2170 do not affect the teachings of the present invention. The variants of processor module 2120, memory module 2160 and network interface module 2170 usable in the context of the present invention will be readily apparent to persons skilled in the art.

A bus 2180 is depicted as an example of means for exchanging data between the different modules of the network node 2100. The present invention is not affected by the way the different modules exchange information. For instance, the memory module 2160 and the processor module 2120 could be connected by a parallel bus, but could also be connected by a serial connection or involve an intermediate module (not shown) without affecting the teachings of the present invention.

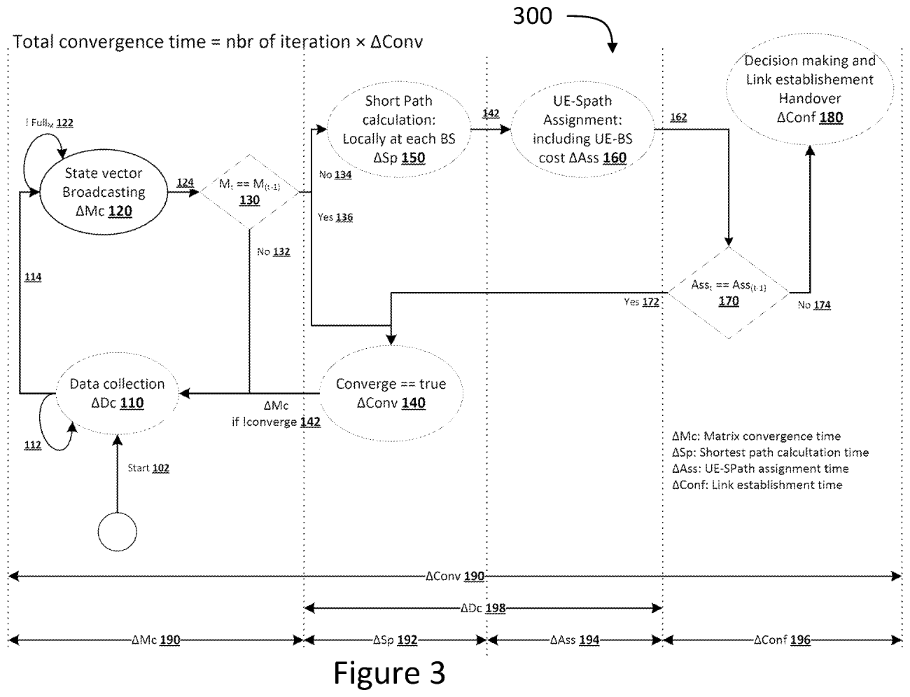

FIG. 3 present an example of a method 300 depicted as a state machine that supports resource (re) deployment and routing determination in a network. Starting from 102, data collection 110 is performed until 112 data on adjacent node costs are gathered. Thereafter 114, once computed 122, a state vector containing link costs with adjacent network nodes is broadcast 120. 124 a matrix is built for each cluster (e.g., shared by each CH between clusters). If 130 the computed matrix is the same as the matrix from the very last iteration 136, the matrix has converged 140 and 142 data collection 110 resumes (e.g., upon any modification). If 130 the matrix is not the same as the one from a prior iteration (or on a first iteration), 132 the data collection 110 is repeated and, 134 the shortest path to core network calculation 150 is performed. 142 an assignment 160 is then computed. 162 if 170 the assignment is the same as the present assignment, then 172 we have convergence 140. Otherwise 174, assignment of active ones of the served nodes to proper ones of the serving nodes considering the computed shortest paths is performed 180.

M1: SNR

| | BS1 | BS2 | BS3 |
|---|---|---|---|
| BS1 | 0 | 1 | 1 |
| BS2 | 1 | 0 | 0 |
| BS3 | 0 | 1 | 0 |

M2: Distance

| | BS1 | BS2 | BS3 |
|---|---|---|---|
| BS1 | 0 | 1 | 1 |
| BS2 | 1 | 0 | 0 |
| BS3 | 0 | 1 | 0 |

M3: RSRP

| | BS1 | BS2 | BS3 |
|---|---|---|---|
| BS1 | 0 | 1 | 1 |
| BS2 | 1 | 0 | 0 |
| BS3 | 0 | 1 | 0 |

M4: RSRQ

| | BS1 | BS2 | BS3 |
|---|---|---|---|
| BS1 | 0 | 1 | 1 |
| BS2 | 1 | 0 | 0 |
| BS3 | 0 | 1 | 0 |

M5: energy = {flying, tx}

| | BS1 | BS2 | BS3 |
|---|---|---|---|
| BS1 | 0 | 1 | 1 |
| BS2 | 1 | 0 | 0 |
| BS3 | 0 | 1 | 0 |

[symbol]

M6: m1ᵢⱼ*m2ᵢⱼ*m3ᵢⱼ*m4ᵢⱼ*m5ᵢⱼ

| | BS1 | BS2 | BS3 |
|---|---|---|---|
| BS1 | 0 | 1 | 1 |
| BS2 | 1 | 0 | 0 |
| BS3 | 0 | 1 | 0 |

| | RSRP (dBm) | RSRQ (dB) | SINR (dB) |
|---|---|---|---|
| Excel- | RSRP > −90 | RSRQ > −5 | SINR > 15 |
| lent | | | |
| Good | −90 > RSRP > −100 | −5 > RSRQ > −10 | 15 > SINR > 10 |
| Regular | −100 > RSRP > −110 | −10 > RSRQ > −15 | 10 > SINR > 5 |
| Bad | RSRP < −110 | RSRQ < −15 | SINR < 5 |

M6: m1ᵢⱼ*m2ᵢⱼ*m3ᵢⱼ*m4ᵢⱼ*m5ᵢⱼ

| | BS1 | BS2 | BS3 |
|---|---|---|---|
| BS1 | 0 | 1 | 1 |
| BS2 | 1 | 0 | 0 |
| BS3 | 0 | 1 | 0 |

[symbol]

M7: If m6ᵢⱼ = 0 → m7ᵢⱼ = inf
Else → m7ᵢⱼ = costᵢⱼ

| | BS1 | BS2 | BS3 |
|---|---|---|---|
| BS1 | inf | costᵢⱼ | costᵢⱼ |
| BS2 | costᵢⱼ | inf | inf |
| BS3 | inf | costᵢⱼ | inf |

M1: SNR

| | BS1 | BS2 | BS3 |
|---|---|---|---|
| UE1 | 0 | 1 | 1 |
| UE2 | 1 | 0 | 0 |
| UE3 | 0 | 1 | 0 |

M2: RSRP

| | BS1 | BS2 | BS3 |
|---|---|---|---|
| UE1 | 0 | 1 | 1 |
| UE2 | 1 | 0 | 0 |
| UE3 | 0 | 1 | 0 |

M3: RSRQ

| | BS1 | BS2 | BS3 |
|---|---|---|---|
| UE1 | 0 | 1 | 1 |
| UE2 | 1 | 0 | 0 |
| UE3 | 0 | 1 | 0 |

[symbol]

M4: m1ᵢⱼ*m2ᵢⱼ*m3ᵢⱼ

| | BS1 | BS1 | BS3 |
|---|---|---|---|
| UE1 | 0 | 1 | 1 |
| UE2 | 1 | 0 | 0 |
| UE3 | 0 | 1 | 0 |

[symbol]

M5: If m4ᵢⱼ = 0 → m5ᵢⱼ = inf
Else → m5ᵢⱼ = costUᵢBⱼ + cost(S.pathBⱼ)

| | BS1 | BS2 | BS3 |
|---|---|---|---|
| UE1 | inf | costᵢⱼ | costᵢⱼ |
| UE2 | costᵢⱼ | inf | inf |
| UE3 | inf | costᵢⱼ | inf |

### Multi-Agent Assignment Algo.

UEs [symbol] Shortest paths

| | BS1 | BS2 | BS3 |
|---|---|---|---|
| UE1 | inf | costᵢⱼ | costᵢⱼ |
| UE2 | costᵢⱼ | inf | inf |
| UE3 | inf | costᵢⱼ | inf |

C = [max_PRB_j]
D = [req_PRB_Ui]

Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

The present invention is not affected by the way the different modules exchange information between them. For instance, the memory module and the processor module could be connected by a parallel bus, but could also be connected by a serial connection or involve an intermediate module (not shown) without affecting the teachings of the present invention.

A method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for deploying resources in a network, the network comprising a plurality of network nodes composed of served nodes and serving nodes, the serving nodes comprising a plurality of cluster heads, the method comprising:
dividing a served geographic zone into a plurality of multidimensional horizontal clusters based on a multi-dimensional vector of different features including:
number of the served nodes;
position values of the served nodes; and
traffic flow type values for the served nodes;
assigning one of the CH nodes to each of the plurality of multidimensional horizontal clusters considering:
capacity of the assigned CH node; and
deployment delay of the assigned CH node; and
assigning one of the serving nodes to the each of the plurality of multidimensional horizontal clusters considering:
capacity of the assigned serving node;
required capacity to serve a particular one of the plurality of multidimensional horizontal clusters; and
a distance constraint between two or more of the served nodes to avoid wireless-interference.

2. The method of claim 1, wherein each of the plurality of multidimensional horizontal clusters is further divided in subzones.

3. The method of claim 2, further comprising automatically triggering repositioning of one or more serving nodes in the network considering dynamic thresholds.

4. The method of claim 3, wherein the dynamic thresholds are related to one or more of:
remaining execution time in terms of network resources, computational resources and/or storage resources;
energy/power requirements;
deployment/execution delay of one or more serving nodes;
predicted time of the environment condition changes; and
remaining time for displacing the one or more serving node to the center of a target subzone.

5. The method of claim 1, further comprising:
dividing each of the plurality of horizontal multidimensional clusters (HMC) into a plurality of sub-clusters (sub-HMC clusters);
assigning a subset of the network nodes to each of the plurality of sub-clusters thereby defining vertical multidimensional clusters (VMC) of network nodes

6. The method of claim 5, further comprising dividing each of the sub-HMC clusters into sub-sub-HMC clusters and so on thereby creating a hierarchy of clusters of network nodes

7. The method of claim 1, further comprising self-tuning deployment of resources in the network by:
proactively executing a cost-optimization function considering a set of constraints comprising a plurality of:
geographic zone of the served nodes;
position of the network nodes;
mobility capabilities of the network nodes;
energy capabilities of network nodes;
resource requirements of the network nodes;
type of the network nodes;
type of the served traffic flow; and
instantaneous bandwidth (IBW); and
wherein various ones of the network nodes can belong to a given cluster when sharing similar cost functions.

8. The method of claim 7, further comprising tuning a subset of the constraints for optimizing stability, security, safety and radio network performance in the network.

9. The method of claim 1, further comprising determining traffic routes in the network by iterating:
at each of the network nodes, maintaining a list of adjacent network nodes;
at each node, broadcasting a state vector containing link costs with adjacent network nodes;
at each node, creating a matrix of link costs between all pairs of the network nodes;
based on this matrix, each of the serving nodes computing a shortest path to a core network; and
assigning active ones of the served nodes to proper ones of the serving nodes considering the computed shortest paths;
until a converging solution is found.

10. The method of claim 9, further comprising, at each node, computing the costs of the link with adjacent nodes as a product of a network function and the feasibility of that link considering that a link is feasible if all constraints are met, a constraint is defined for each metric, a cost of an infeasible link is infinite.

11. A system comprising:
a network comprising a plurality of network nodes composed of served nodes and serving nodes, the serving nodes comprising a plurality of cluster heads; and
one or more processors configured to:
divide a served geographic zone into a plurality of multidimensional horizontal clusters based on a multi-dimensional vector of different features including:
number of the served nodes;
position values of the served nodes; and
traffic flow type values for the served nodes;
assign one of the CH nodes to each of the plurality of multidimensional horizontal clusters considering:
capacity of the assigned CH node; and
deployment delay of the assigned CH node; and
assign one of the serving nodes to the each of the plurality of multidimensional horizontal clusters considering:
capacity of the assigned serve node;
required capacity to serve a particular one of the plurality of multidimensional horizontal clusters; and
a distance constraint between two or more of the served nodes to avoid wireless-interference.

12. The system of claim 11, wherein each of the plurality of multidimensional horizontal clusters is further divided in subzones.

13. The system of claim 12, wherein the one or more processors are further configured to:
automatically trigger repositioning of one or more serving nodes in the network considering dynamic thresholds.

14. The system of claim 13, wherein the dynamic thresholds are related to one or more of:
remaining execution time in terms of network resources, computational resources and/or storage resources;
energy/power requirements;
deployment/execution delay of one or more serving nodes;
predicted time of the environment condition changes; and
remaining time for displacing the one or more serving node to the center of a target subzone.

15. The system of claim 11, wherein the one or more processors are further configured to:
divide each of the plurality of horizontal multidimensional clusters (HMC) into a plurality of sub-clusters (sub-HMC clusters); and
assign a subset of the network nodes to each of the plurality of sub-clusters thereby defining vertical multidimensional clusters (VMC) of network nodes.

16. The system of claim 15, wherein the one or more processors are further configured to:
divide each of the sub-HMC clusters into sub-sub-HMC clusters and so on thereby creating a hierarchy of clusters of network nodes.

17. The system of claim 11, wherein the one or more processors are further configured to self-tune deployment of resources in the network by:
proactively execute a cost-optimization function considering a set of constraints comprising a plurality of:
geographic zone of the served nodes;
—position of the network nodes;
—mobility capabilities of the network nodes;
—energy capabilities of network nodes;
—resource requirements of the network nodes;
—type of the network nodes;
—type of the served traffic flow; and
—instantaneous bandwidth (IBW); and
—wherein various ones of the network nodes can belong to a given cluster when share similar cost functions.

18. The system of claim 17, wherein the one or more processors are further configured to tune a subset of the constraints for optimizing stability, security, safety and radio network performance in the network.

19. The system of claim 11, wherein the one or more processors are further configured to route traffic the network by iterating:
—at each of the network nodes, maintain a list of adjacent network nodes;
—at each node, broadcast a state vector containing link costs with adjacent network nodes;
—at each node, create a matrix of link costs between all pairs of the network nodes;
—based on this matrix, each of the serving nodes compute a shortest path to a core network; and
—assign active ones of the served nodes to proper ones of the serving nodes considering the computed shortest paths; and
—until a converging solution is found.

20. The system of claim 19, wherein the one or more processors are further configured to, at each node, compute the costs of the link with adjacent nodes as a product of a network function and the feasibility of that link considering that a link is feasible if all constraints are met, a constraint is defined for each metric, a cost of an infeasible link is infinite.
